(19) United States
(12) Patent Application Publication
(10) Pub. No.: US 2024/0235428 A9
(43) Pub. Date: Jul. 11, 2024

(54) VIBRATION DEVICE, VIBRATION UNIT, AND VIBRATION APPARATUS

(71) Applicant: OMRON Corporation, KYOTO (JP)

(72) Inventors: Shogo NAGASAKA, Kyoto-shi (JP); Yoshinori SHIMIZU, Kyoto-shi (JP)

(73) Assignee: OMRON Corporation, KYOTO (JP)

(21) Appl. No.: 18/463,250

(22) Filed: Sep. 7, 2023

(30) Foreign Application Priority Data
Oct. 21, 2022 (JP) 2022-168937

(51) Int. Cl. H02N 2/00; A63F 13/285

(52) U.S. Cl. CPC H02N 2/001; A63F 13/285; H02N 2/005; G08B 6/00

(57) ABSTRACT

A vibration device includes vibration elements arranged side by side in a plane direction of a thin film, and the vibration elements are capable of being controlled in different vibrations respectively. The vibration device includes vibration elements having different frequencies of vibration. Further, the vibration device includes vibration elements having different phases. A vibration unit includes the vibration device and a control part controlling vibration of the vibration elements included in the vibration device. A vibration apparatus includes the vibration device, the control part, and a housing accommodating the vibration device and the control part, and includes a vibration part arranged on an outer surface of the housing and generating vibration caused by the vibration elements included in the vibration device.

### CROSS-REFERENCE TO RELATED APPLICATION

This application claims the priority benefit of Japan application serial no. 2022-168937, filed on Oct. 21, 2022. The entirety of the above-mentioned patent application is hereby incorporated by reference herein and made a part of this specification.

### BACKGROUND

### Technical Field

The disclosure relates to a vibration device including vibration elements, a vibration unit including the vibration device, and a vibration apparatus including the vibration unit.

### Related Art

Devices using vibration elements that generate vibration transmitted to a user touching the device have become widespread, including operation devices such as game controllers, communication devices such as smartphones and tablet computers, and various other electronic devices. For example, Patent Document 1 (Japanese Patent Application Laid-Open No. 2005-339298) has proposed an input device that vibrates a contact part of a finger and transmits vibration to the user by supplying a drive signal to an actuator (vibration element) in a thin sheet shape (thin film shape) such as a piezoelectric actuator.

In the case of using a vibration element in a thin film shape as disclosed in Patent Document 1, effective transmission of vibration is an issue.

### SUMMARY

A vibration device according to an embodiment disclosed in this application includes a plurality of vibration elements formed in a shape of a thin film. The plurality of vibration elements are arranged side by side in a plane direction of the thin film. The plurality of vibration elements are capable of being controlled in different vibrations respectively.

Further, in the vibration device, vibrations of a first vibration element and a second vibration element among the plurality of vibration elements have different frequencies.

Further, in the vibration device, a difference in frequency between vibrations of a first vibration element and a second vibration element among the plurality of vibration elements is 1 to 50 Hz.

Further, in the vibration device, a vibration of a third vibration element among the plurality of vibration elements has a same frequency as that of the first vibration element and has a phase different from that of the first vibration element.

Further, in the vibration device, vibrations of a first vibration element and a second vibration element among the plurality of vibration elements have a same frequency and have different phases.

Further, in the vibration device, vibrations of a first vibration element and a second vibration element among the plurality of vibration elements have a same frequency and are in opposite phases.

Further, in the vibration device, a frequency of vibration of the plurality of vibration elements is 50 to 500 Hz.

Furthermore, a vibration unit according to an embodiment disclosed in this application includes the vibration device described above and a control part that controls vibration of the vibration elements included in the vibration device.

Furthermore, a vibration apparatus according to an embodiment disclosed in this application includes the vibration device described above, a control part that controls vibration of the vibration elements included in the vibration device, a housing that accommodates the vibration device and the control part, and a vibration part that is arranged on an outer surface of the housing and generates vibration caused by the vibration elements included in the vibration device.

The vibration device according to an embodiment disclosed in this application includes a plurality of vibration elements in a thin film shape and achieves excellent effects such as being capable of effectively transmitting vibration generated by the vibration elements.

### BRIEF DESCRIPTION OF THE DRAWINGS

FIG. 1 is a schematic external view showing an example of the appearance of a vibration apparatus disclosed in this application.

FIG. 2 is a schematic external view showing an example of the appearance of the vibration apparatus disclosed in this application.

FIG. 3 is a schematic perspective view showing an example of the inside of the vibration apparatus disclosed in this application.

FIG. 4 is a schematic external view schematically showing an example of a vibration device disclosed in this application.

FIG. 5 is a circuit block diagram schematically showing an example of the functional configuration of a vibration unit disclosed in this application.

FIG. 6 is a graph showing an example of the influence of frequency on skin sensation of the human body.

FIG. 7 is a graph showing an example of waveforms for vibrating at different frequencies.

FIG. 8 is a schematic external view schematically showing an example of the vibration device disclosed in this application.

FIG. 9 is a circuit block diagram schematically showing an example of the functional configuration of the vibration unit disclosed in this application.

### DESCRIPTION OF THE EMBODIMENTS

Embodiments of the disclosure provide a vibration device capable of effectively transmitting vibration using vibration elements in a thin film shape.

Further, embodiments of the disclosure provide a vibration unit including the vibration device according to the disclosure.

Further, embodiments of the disclosure provide a vibration apparatus including the vibration device according to the disclosure.

### Application Example

Hereinafter, embodiments will be described with reference to the drawings. A vibration apparatus disclosed in this application is applied to a device that conveys a status or information to a user by vibration, such as a game device with an operation part and a display part integrated, a controller for a game device, etc. Hereinafter, a vibration apparatus VA applied to a game device will be described as an example with reference to the drawings.

<Appearance of Vibration Apparatus VA>

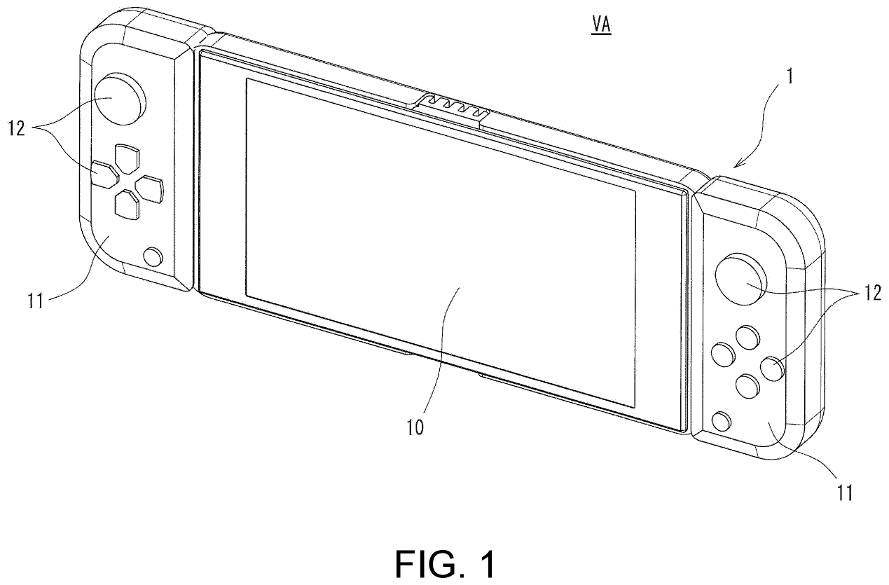

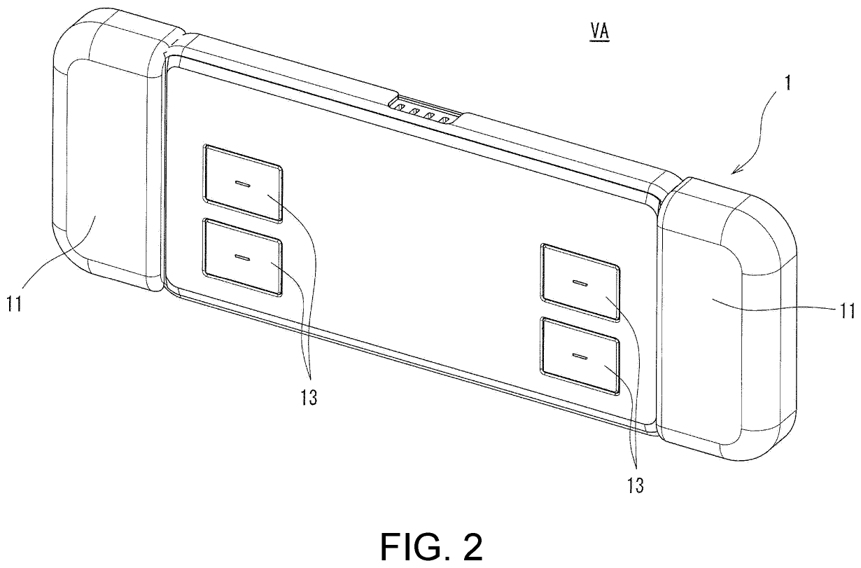

FIG. 1 and FIG. 2 are schematic external views showing an example of the appearance of the vibration apparatus VA disclosed in this application. FIG. 1 is a schematic perspective view showing a front surface side of the vibration apparatus VA, and FIG. 2 is a schematic perspective view showing a back surface side of the vibration apparatus VA. The vibration apparatus VA includes a housing 1 that forms a substantially rectangular plate shape. A display part 10, such as a rectangular liquid crystal panel, is arranged at the center of the front surface of the housing 1. Grip parts 11 to be gripped by the user are arranged on left and right sides of the display part 10. Operation parts 12 such as operation buttons to be operated by the user with his or her thumbs are arranged at the grip parts 11. On the back surface (outer surface) of the housing 1, vibration parts 13 that generate vibration are arranged at four positions touched by fingers other than the thumbs of the user.

<Internal Structure of Vibration Apparatus VA>

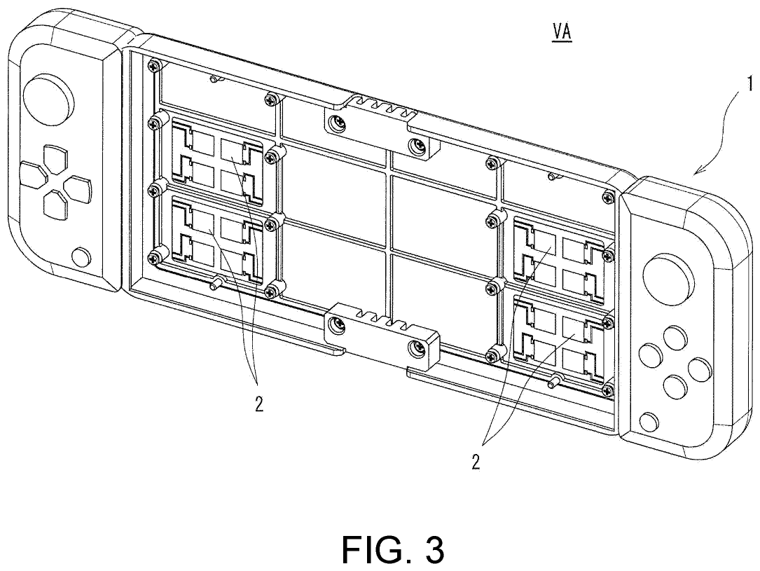

FIG. 3 is a schematic perspective view showing an example of the inside of the vibration apparatus VA disclosed in this application. In FIG. 3, the display part 10 arranged on the front surface of the housing 1 of the vibration apparatus VA is removed to be capable of visually recognizing the internal structure. To make the inside of the vibration apparatus VA more visually recognizable, FIG. 3 only shows the housing 1 and vibration devices 2 arranged inside the housing 1. As illustrated in FIG. 3, four vibration devices 2 are arranged inside the housing 1, and the arrangement positions of the vibration devices 2 correspond to the positions of the vibration parts 13 on the back surface of the housing 1. With this arrangement, vibration of the vibration devices 2 is transmitted to the user's fingertips via the vibration parts 13 of the housing 1.

<Structure of Vibration Device 2>

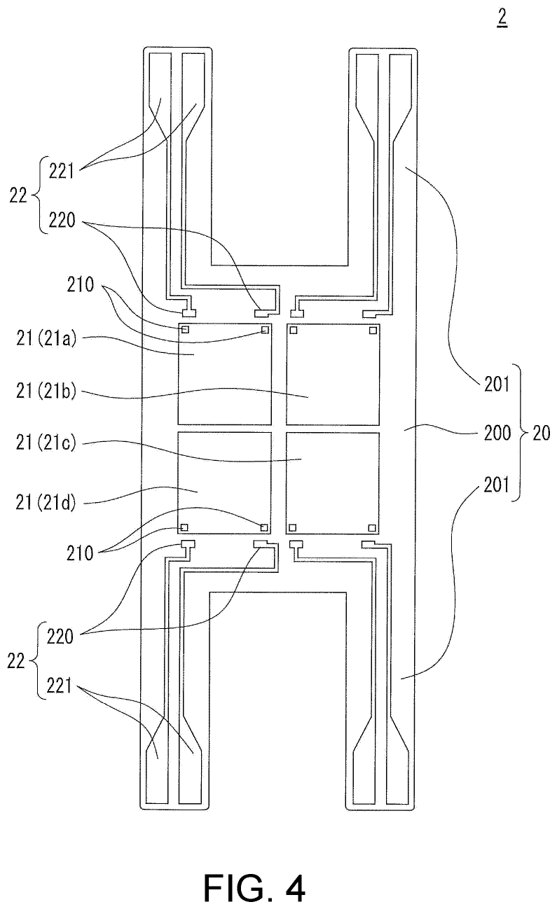

FIG. 4 is a schematic external view schematically showing an example of the vibration device 2 disclosed in this application. The vibration device 2 includes a substrate 20, vibration elements 21 arranged on the substrate 20, and printed wirings 22 formed on the substrate 20.

The substrate 20 is, for example, a flexible printed substrate (FPC substrate) in a thin film shape having flexibility. The substrate 20 includes an element arrangement part 200 that forms a substantially rectangular shape, and terminal arrangement parts 201 that respectively extend from the vicinity of four vertices of the element arrangement part 200. The terminal arrangement parts 201 extend in a direction (up-down direction in FIG. 4) extending from the respective vertices of the element arrangement part 200 along the long sides.

Four vibration elements 21 forming a thin film shape are arranged side by side in a plane direction of the thin film at the element arrangement part 200 of the substrate 20. The thin film shape of the vibration element 21 refers to a shape of a sheet having a small thickness, and the plane direction represents a spreading direction of the sheet, that is, a direction that is substantially orthogonal to a direction of the small thickness. In the embodiment illustrated in FIG. 4, four vibration elements 21 that form substantially square shapes in a plan view are arranged side by side in a 2×2 grid pattern without overlapping with each other. Each vibration element 21 is sized and arranged such that in the case where the finger of the user using the vibration apparatus VA touches the vibration part 13 arranged at the housing 1, the finger touches multiple vibration elements 21 at the same time. Herein, the “plan view” refers to a viewpoint from a normal direction with respect to the plane of the thin film. The vibration element 21 is formed using a piezoelectric element having piezoelectricity such as lead zirconate titanate (PZT), and vibrates by energization. A pair of element electrode parts 210 are formed at each vibration element 21, and the vibration element 21 receives energization via the element electrode parts 210. In the following description, in the case of distinguishing individual vibration elements 21, the vibration elements 21 will be referred to as a first vibration element 21a, a second vibration element 21b, a third vibration element 21c, and a fourth vibration element 21d.

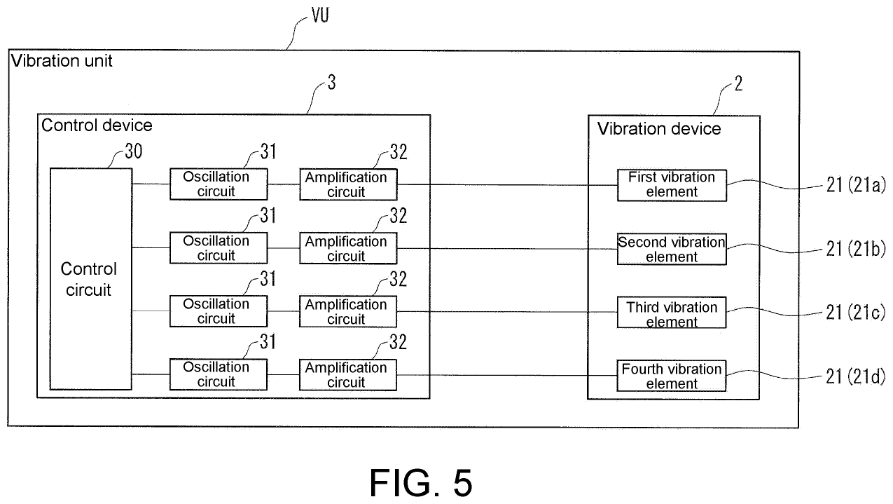

A pair of printed wirings 22 are connected to each vibration element 21. One end of the printed wiring 22 serves as a wiring electrode part 220 connected to the vibration element 21, and the other end of the printed wiring 22 serves as a terminal part 221. The wiring electrode part 220 of the printed wiring 22 is positioned at the element arrangement part 200, and the terminal part 221 side of the printed wiring 22 extending from the wiring electrode part 220 is formed along the terminal arrangement part 201. The element electrode part 210 of the vibration element 21 and the wiring electrode part 220 of the printed wiring 22 are electrically connected by a conductive adhesive (not shown) such as a silver paste. Each terminal part 221 is electrically connected to a control device 3 (control part, see FIG. 5 and other figures) that controls vibration of each vibration element 21.

<Control Structure of Vibration Unit VU>

The vibration device 2 and a control device 3 that controls vibration of the vibration elements 21 included in the vibration device 2 are accommodated in the housing 1 included in the vibration apparatus VA. A vibration unit VU is composed of the vibration device 2 and the control device 3. FIG. 5 is a circuit block diagram schematically showing an example of the functional configuration of the vibration unit VU disclosed in this application. The control device 3 included in the vibration unit VU includes a control circuit 30, oscillation circuits 31, and amplification circuits 32. In the embodiment illustrated in FIG. 5, the oscillation circuits 31 and the amplification circuits 32 are provided for each vibration device 2 and are controlled by one control circuit 30. The control circuit 30 is a processor that controls vibration of each vibration device 2 and outputs a control signal controlling vibration to each oscillation circuit 31. Each oscillation circuit 31 outputs, to the corresponding amplification circuit 32, an electrical signal of a waveform based on the inputted control signal. Each amplification circuit 32 amplifies the inputted electrical signal to generate a drive signal for driving the vibration element 21, and outputs the generated drive signal to the corresponding vibration device 2. Each vibration device 2 applies a voltage of the waveform inputted as the drive signal to the corresponding vibration element 21 to vibrate the respective vibration elements 21.

The waveform related to the vibration of the vibration element 21 is a waveform having periodicity such as a sine wave, a sawtooth wave, and a square wave. Hereinafter, an embodiment in which the vibration element 21 is vibrated according to a sine wave will be described as an example. By controlling with the control device 3, it is possible to vibrate each vibration element 21 according to different waveforms. Although it is also possible to control the amplitude of the waveform of vibration of each vibration element 21 to be different from each other, herein, an embodiment in which the vibration elements 21 are all controlled according to waveforms of the same amplitude will be described as an example.

Each vibration element 21 is controlled to generate vibration having the same amplitude and different frequencies and/or phases. The amplitude refers to an amplitude of the voltage (drive signal) applied to each vibration element 21, or a width of physical distortion of each vibration element 21. The frequency of each vibration element 21 is controlled between 50 and 500 Hz, and is preferably around 200 Hz. The difference in frequency between the vibration elements 21 vibrating at different frequencies is controlled between 1 and 50 Hz, and is preferably controlled in the range of 2 to 3 Hz. The vibration elements 21 vibrating at the same frequency are controlled in different phases, and particularly, are preferably set to opposite phases. For example, the first vibration element 21a is controlled at 200 Hz, the second vibration element 21b is controlled at 203 Hz, the third vibration element 21c arranged diagonally with respect to the first vibration element 21a is controlled at 200 Hz, and the fourth vibration element 21d arranged diagonally with respect to the second vibration element 21b is controlled at 203 Hz. Further, control is performed such that the first vibration element 21a and the third vibration element 21c are in opposite phases, and control is performed such that the second vibration element 21b and the fourth vibration element 21d are in opposite phases.

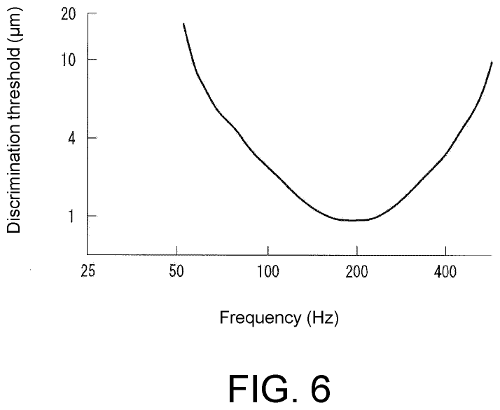

FIG. 6 is a graph showing an example of the influence of frequency on skin sensation of the human body. In FIG. 6, the horizontal axis represents a frequency, and the vertical axis represents a discrimination threshold at which Pacinian corpuscles perceive a vibration amplitude, and the relationship therebetween is shown. Pacinian corpuscles are one of mechanical receptors found in human skin. As shown in the graph in FIG. 6, Pacinian corpuscles are most sensitive to vibration of a frequency around 200 Hz and are capable of perceiving even an amplitude of about 1 μm. Thus, the frequency related to vibration of each vibration element 21 is preferably controlled to 50 to 500 Hz, and particularly, is preferably controlled to around 200 Hz.

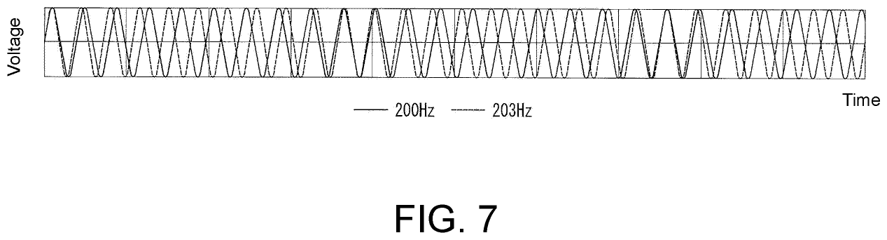

FIG. 7 is a graph showing an example of waveforms for vibrating at different frequencies. FIG. 7 superposes and shows the waveform of the first vibration element 21a vibrating at 200 Hz and the waveform of the second vibration element 21b vibrating at 203 Hz, with the horizontal axis representing time and the vertical axis representing a voltage as a signal value. In the figure, a solid line represents the waveform of the first vibration element 21a, and a dashed line represents the waveform of the second vibration element 21b. In the case where a part of the human body such as a finger touches the first vibration element 21a and the second vibration element 21b at the same time, a vibration waveform of 200 Hz and a vibration waveform of 203 Hz are felt at the same time. In general, the skin sensation of the human body is more sensitive to vibration with changes than vibration with a constant frequency. By feeling vibrations of different waveforms of 200 Hz and 203 Hz at the same time, the human body will experience a pseudo beat of 3 Hz obtained by combining these waveforms, and can perceive vibration sensitively. The inventors of this application have found through experiments that, in the case where the pseudo beat is 1 to 50 Hz, vibration can be perceived more sensitively than at a constant frequency, and particularly, in the case where the pseudo beat is 2 to 3 Hz, vibration can be perceived most sensitively. Thus, the difference in frequency between the vibration elements 21 is preferably 1 to 50 Hz, and particularly, is preferably set to 2 to 3 Hz.

Further, the inventors of this application have found through experiments that, even at the same frequency, in the case where the phase is different, vibration can be perceived more sensitively than in the same phase, and particularly, by setting to opposite phases, vibration can be perceived most sensitively. Thus, as an embodiment, this application discloses a control method that controls, in opposite phases, the first vibration element 21a and the third vibration element 21c arranged at diagonal positions, and controls, in opposite phases, the second vibration element 21b and the fourth vibration element 21d.

<Other Embodiments of Vibration Device 2>

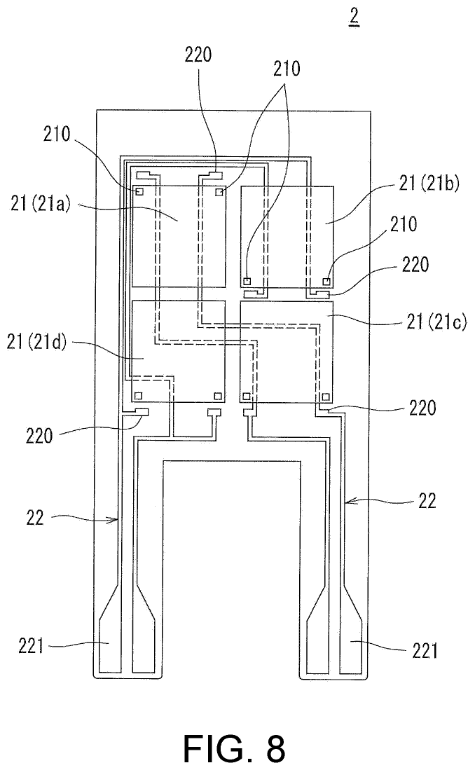

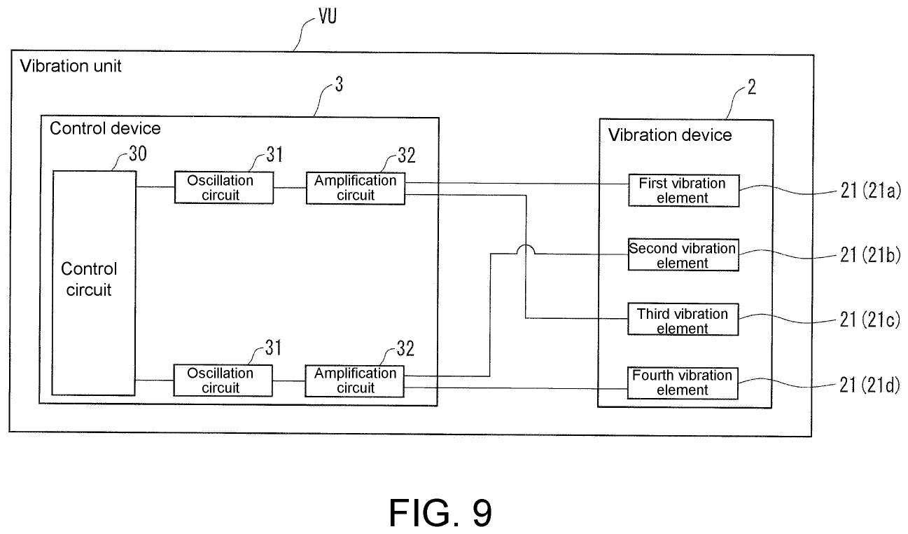

FIG. 8 is a schematic external view schematically showing an example of the vibration device 2 disclosed in this application. FIG. 9 is a circuit block diagram schematically showing an example of the functional configuration of the vibration unit VU disclosed in this application. FIG. 8 and FIG. 9 show another embodiment of the vibration device 2. The vibration device 2 illustrated in FIG. 8 and FIG. 9 controls multiple vibration elements 21 with one set of the oscillation circuit 31 and the amplification circuit 32, rather than independently controlling each of the first vibration element 21a to the fourth vibration element 21d. In the embodiment illustrated in FIG. 8 and FIG. 9, the first vibration element 21a and the third vibration element 21c are controlled by a first set of the oscillation circuit 31 and the amplification circuit 32, and the second vibration element 21b and the fourth vibration element 21d are controlled by a second set of the oscillation circuit 31 and the amplification circuit 32. Since two vibration elements 21 are controlled by one set of the oscillation circuit 31 and the amplification circuit 32, the two controlled vibration elements 21 vibrate at the same frequency. However, it is possible to reverse the phase by reversing the polarity of the printed wiring 22 at the respective vibration elements 21. In the embodiment illustrated in FIG. 8 and FIG. 9, the vibration unit VU disclosed in this application can control the first vibration element 21a and the third vibration element 21c to opposite phases at the frequency of 200 Hz, and control the second vibration element 21b and the fourth vibration element 21d to opposite phases at the frequency of 203 Hz.

As described above, in the vibration device 2 disclosed in this application, a plurality of vibration elements 21 in a thin film shape are arranged side by side and are controlled to perform different vibrations. Thus, since the vibration device 2 disclosed in this application is capable of generating vibration that can be sensitively perceived by the user, excellent effects are achieved, such as being capable of effectively transmitting vibrations generated by the vibration elements 21.

In addition, in the vibration device 2 disclosed in this application, the vibration frequency of the vibration elements 21 is set to 50 to 500 Hz, the difference in frequency between the vibration elements 21 is set to 1 to 50 Hz, and further the vibration elements 21 are set to opposite phases even at the same vibration frequency. Thus, excellent effects are achieved, such as being capable of generating vibration that is easy to perceive.

The disclosure is not limited to the embodiments described above, and may be implemented in various other forms. Thus, the above embodiments are simply illustrative in all respects and should not be interpreted as restrictive. The technical scope of the disclosure is described according to the claims and is not bound by the text of the description. Furthermore, all modifications and changes that belong to the equivalent scope of the claims are within the technical scope of the disclosure.

For example, in the above embodiments, it has been shown that four vibration elements 21 are incorporated into the vibration device 2 as a set, but the disclosure is not limited thereto, and it is possible to incorporate a plurality of vibration elements 21 such as two, three, five or more vibration elements 21 into one vibration device 2. Further, in that case, in the vibration device 2 according to the disclosure, the frequency and phase of each vibration element 21 may be appropriately set. Furthermore, for example, the vibration device 2 according to the disclosure may also include vibration elements 21 having the same frequency and phase among the plurality of vibration elements 21.

Further, for example, in the above embodiments, it has been shown that the vibration apparatus VA disclosed in this application is applied to a controller for a game device, but the vibration apparatus VA disclosed in this application is not limited thereto. The vibration apparatus VA disclosed in this application may be applied to various devices that convey a status or information to the user by vibration, such as smartphones and tablet computers.

What is claimed is:

1. A vibration device comprising:
a plurality of vibration elements formed in a shape of a thin film, wherein
the plurality of vibration elements are arranged side by side in a plane direction of the thin film, and
the plurality of vibration elements are capable of being controlled in different vibrations respectively.

2. The vibration device according to claim 1, wherein
vibrations of a first vibration element and a second vibration element among the plurality of vibration elements have different frequencies.

3. The vibration device according to claim 1, wherein
a difference in frequency between vibrations of a first vibration element and a second vibration element among the plurality of vibration elements is 1 to 50 Hz.

4. The vibration device according to claim 2, wherein
a vibration of a third vibration element among the plurality of vibration elements has a same frequency as that of the first vibration element and has a phase different from that of the first vibration element.

5. The vibration device according to claim 3, wherein
a vibration of a third vibration element among the plurality of vibration elements has a same frequency as that of the first vibration element and has a phase different from that of the first vibration element.

6. The vibration device according to claim 1, wherein
vibrations of a first vibration element and a second vibration element among the plurality of vibration elements have a same frequency and have different phases.

7. The vibration device according to claim 1, wherein
vibrations of a first vibration element and a second vibration element among the plurality of vibration elements have a same frequency and are in opposite phases.

8. The vibration device according to claim 1, wherein
a frequency of vibration of the plurality of vibration elements is 50 to 500 Hz.

9. The vibration device according to claim 2, wherein
a frequency of vibration of the plurality of vibration elements is 50 to 500 Hz.

10. The vibration device according to claim 3, wherein
a frequency of vibration of the plurality of vibration elements is 50 to 500 Hz.

11. The vibration device according to claim 6, wherein
a frequency of vibration of the plurality of vibration elements is 50 to 500 Hz.

12. The vibration device according to claim 7, wherein
a frequency of vibration of the plurality of vibration elements is 50 to 500 Hz.

13. A vibration unit comprising:
the vibration device according to claim 1; and
a control part that controls vibration of the vibration elements included in the vibration device.

14. A vibration unit comprising:
the vibration device according to claim 2; and
a control part that controls vibration of the vibration elements included in the vibration device.

15. A vibration unit comprising:
the vibration device according to claim 3; and
a control part that controls vibration of the vibration elements included in the vibration device.

16. A vibration unit comprising:
the vibration device according to claim 6; and
a control part that controls vibration of the vibration elements included in the vibration device.

17. A vibration unit comprising:
the vibration device according to claim 7; and
a control part that controls vibration of the vibration elements included in the vibration device.

18. A vibration apparatus comprising:
the vibration device according to claim 1;
a control part that controls vibration of the vibration elements included in the vibration device;
a housing that accommodates the vibration device and the control part; and
a vibration part that is arranged on an outer surface of the housing and generates vibration caused by the vibration elements included in the vibration device.

19. A vibration apparatus comprising:
the vibration device according to claim 2;
a control part that controls vibration of the vibration elements included in the vibration device;
a housing that accommodates the vibration device and the control part; and
a vibration part that is arranged on an outer surface of the housing and generates vibration caused by the vibration elements included in the vibration device.

20. A vibration apparatus comprising:
the vibration device according to claim 3;
a control part that controls vibration of the vibration elements included in the vibration device;
a housing that accommodates the vibration device and the control part; and
a vibration part that is arranged on an outer surface of the housing and generates vibration caused by the vibration elements included in the vibration device.
